(19) United States
(12) Patent Application Publication
(10) Pub. No.: US 2025/0196444 A1
(43) Pub. Date: Jun. 19, 2025

(54) COMPRESSED STORAGE OF INFORMATION FOR ADDITIVE MANUFACTURING

(71) Applicant: TRUMPF Laser- und Systemtechnik SE, Ditzingen (DE)

(72) Inventors: Marc Gronle, Renningen (DE); Daniel Coupek, Weissach (DE); Joachim Wagner, Stuttgart (DE)

(21) Appl. No.: 19/073,061

(22) Filed: Mar. 7, 2025

Related U.S. Application Data
(63) Continuation of application No. PCT/EP2023/072596, filed on Aug. 16, 2023.

(30) Foreign Application Priority Data
Sep. 9, 2022 (DE) 10 2022 122 916.5

(51) Int. Cl. B29C 64/393; B29C 64/153; B29C 64/268; B33Y 50/02

(52) U.S. Cl. CPC B29C 64/393; B29C 64/153; B29C 64/268; B33Y 50/02

(57) ABSTRACT

A computer-implemented method for reducing a volume of data in a file for controlling additive manufacturing of a component by guiding a tool along manufacturing coordinates includes identifying a first region to be manufactured, and (I) identifying a filling of the first region, calculating a vector characterizing an outline of the first region, storing the vector in the file, and storing an algorithm for calculating the manufacturing coordinates or information relating to the algorithm in the file, so that the vector and the algorithm form manufacturing parameters, and/or (II) storing the manufacturing coordinates or the manufacturing parameters of the first region in the file, identifying a second region to be manufactured offset from the first region and identically to the first region, and storing a position of the second region and information indicating that the second region is to be manufactured identically to the first region in the file.

### CROSS REFERENCE TO RELATED APPLICATIONS

This application is a continuation of International Application No. PCT/EP2023/072596 (WO 2024/052069 A1), filed on Aug. 16, 2023, and claims benefit to German Patent Application No. DE 10 2022 122 916.5, filed on Sep. 9, 2022. The aforementioned applications are hereby incorporated by reference herein.

### FIELD

Embodiments of the present invention relate to a computer-based method for reducing the volume of data in a file for controlling additive manufacturing of a component. Embodiments of the present invention also relate to a method for manufacturing the component using the method for reducing the data and to a device for manufacturing the component using such a method.

### BACKGROUND

The method of additive manufacturing for components is well-known. As manufactured components become larger and more complex, files used to control production become larger. They can be several gigabytes in size, which requires a lot of storage space and takes a long time to transfer the data.

U.S. Pat. No. 10,748,306 B2 discloses a method for 3D printers, in which three-dimensional pixel structures (voxels) are interpreted.

US 2015/0158252 A1 discloses a catalog of three-dimensional models for a 3D printer.

A method for compressing and decompressing 3D data has become known from US 2017/0347122 A1.

US 2020/0058138 A1 discloses a method for predicting control information from a plurality of voxels. An error in the control information is determined by comparing the predictions.

### SUMMARY

Embodiments of the present invention provide a computer-implemented method for reducing a volume of data in a file for controlling additive manufacturing of a component by guiding a tool along manufacturing coordinates. The method includes identifying a first region to be manufactured, and (I) identifying a filling of the first region, calculating a vector characterizing an outline of the first region, storing the vector in the file, and storing an algorithm for calculating the manufacturing coordinates of the filling or information relating to the algorithm to be applied in the file, so that the vector and the algorithm form manufacturing parameters which contain information of the manufacturing coordinates, and/or (II) storing the manufacturing coordinates or the manufacturing parameters of the first region in the file, identifying a second region to be manufactured, the second region to be manufactured offset from the first region and to be manufactured identically to the first region, and storing a position of the second region and information indicating that the second region is to be manufactured identically to the first region in the file.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a method for the additive manufacturing of a component and a device for carrying out the method according to some embodiments;

FIG. 2 schematically shows a plan view of a layer of the component from FIG. 1 according to some embodiments; and

FIG. 3 schematically shows a region of the layer from FIG. 2 and a meander shape for guiding a tool to fill the region according to some embodiments.

### DETAILED DESCRIPTION

Embodiments of the invention can significantly reduce the volume of data in a file for additive manufacturing, but without any loss of information.

Embodiments of the present invention provide a computer-implemented method for reducing the volume of data in a file. The file is used to control additive manufacturing of a component, in which a tool is guided along manufacturing coordinates. In the method, a first region to be manufactured is initially identified or determined. Subsequently, in a method part I), the information for filling this first region is stored compactly. At least one vector for characterizing the outline of the first region and an algorithm for calculating the manufacturing coordinates within this outline are stored, wherein the algorithm or a reference to an algorithm stored in a library is stored in the file. Alternatively or additionally, in a method part II) a second region to be manufactured is identified, which is to be manufactured in the same way as the first region but being offset from the first region. The position of the second region is stored in the file and the information that the second region is to be manufactured in the same way as the first region.

According to embodiments of the invention, a “vector” is understood to mean an outline segment, in particular in the form of a line segment or curve segment. The outline segment is preferably defined by a start point, an end point, and, where applicable, by a curvature. Multiple vectors can define more complex shapes such as polygons, splines and non-uniform rational B-splines (NURBS).

The algorithm may include parameterization (e.g. number of lines and/or information on uni-directional or bi-directional exposure).

The method parts I) and II) can represent independent aspects of the invention, which can be combined as desired with other features described here.

The method according to embodiments of the invention enables loss-free, compact storage of all information for calculating the manufacturing coordinates. The method according to embodiments of the invention takes advantage of the fact that recurring filling methods and/or recurring regions only need to be saved once. The recurring fill method/structure can then be called up at any position, thus saving significant storage space. In other words, the common inventive idea is to store an instruction for repeating structures (in the form of an algorithm for filling a region and/or the information to form entire regions in the same way) instead of storing all the coordinates of the repeating structure, thereby saving storage space.

The outline of the filling of the first region can be characterized by several vectors.

The first region can be two-dimensional, so that the vector(s) lie(s) in a plane. As the component to be manufactured is often built up layer-by-layer in additive manufacturing, the choice of a two-dimensional region is particularly advantageous.

The layer of the component to be manufactured can be divided into several, in particular identical, regions to determine the first region, wherein one of these regions is the first region. Another of these regions can be the second region.

The method is further simplified if the outline of the first region is trapezoidal, in particular rectangular.

The filling of the first region, and in particular also of the second region, is preferably carried out by meandering guidance of the tool. Processing can be interrupted by the tool or the tool can be set down between two lines of the meander shape. The tool can be used in parallel lines of the meander shape, always working in the same direction, or it can also be used to machine in opposite directions.

The second region can be manufactured identically to the first region except for its position and a rotation, in particular by ±5°, preferably ±3°, particularly preferably ±2°. This allows an adaptation to a base body on which the component is additively manufactured. The rotation may be necessary because in some cases the installation of the base body can only be carried out accurately within a certain tolerance.

Preferably—to further simplify the method—the second region is manufactured identically to the first region except for its position.

It is understood that, in addition to the second region, at least one further region, in particular several further regions, can be manufactured in the same way as the first region. The more regions are produced the same, the more the file can be compressed.

Embodiments of the invention also provide a method for additive manufacturing of the component, in which first the previously described method is carried out, then the stored file is accessed, then the manufacturing coordinates of the first region or second region are calculated and then the tool is guided based on the manufacturing coordinates.

In a particularly preferred embodiment of the method, the tool is in the form of a laser beam. The laser beam can be guided through a deflection device that is controlled by a control system.

Another preferred method for production is powder bed-based laser fusion (laser metal fusion, LMF).

Embodiments of the invention also provide a device for carrying out a method described above, wherein the device has a computer for reducing the volume of data, the tool, a control system and a memory in which the file is stored.

The control system is designed to read the reduced data from the file and generate appropriate instructions for guiding the tool.

Further advantages of the embodiments of the invention arise from the description and the drawings. Similarly, the features mentioned above and the features still to be explained may each be used on their own or together in any desired combinations according to embodiments of the invention. The embodiments shown and described should not be understood as an exhaustive list, but rather are of an exemplary character.

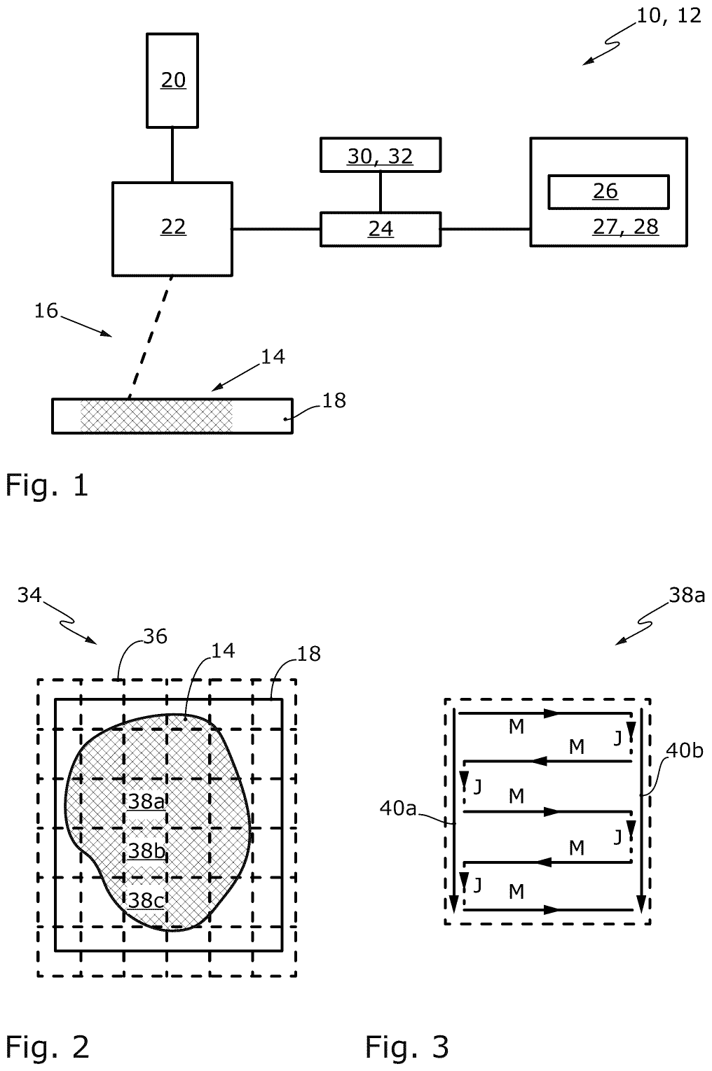

FIG. 1 shows a device 10 and a method 12 for the additive manufacturing of a component 14 with a tool 16. The tool 16 is in the form of a laser beam that at least partially irradiates a layer 18, in this case in the form of a powder bed layer. The laser beam is generated in a beam source 20 and guided by a deflection device 22.

The deflection device 22 is controlled by a control system 24, which accesses a file 26 in a computer 27 or a memory 28 for this purpose. The file 26 can contain manufacturing coordinates for guiding the tool 16. Alternatively or additionally, the file 26 contains manufacturing parameters which require less storage space and are interpreted into manufacturing coordinates by the control system 24. In other words, the control system 24 is designed to calculate manufacturing coordinates for guiding the tool 16 based on the manufacturing parameters contained in the file 26. The controller 24 can preferably be connected to a library 30 in which at least one algorithm 32 for calculating the manufacturing coordinates on the basis of the manufacturing parameters is stored. Alternatively or additionally, the at least one algorithm 32 can be stored directly in the file 26.

FIG. 2 shows a method 34 for reducing the volume of data in the file 26 (see FIG. 1). In the computer 27 (see FIG. 1), a grid 36 is placed over the layer 18 or the virtual component 14 to be produced, so that the component 14 is divided into several regions. For reasons of clarity, only a first region 38a, a second region 38b and a third region 38c are provided with a reference sign in FIG. 2.

The sections 38a, b are identical—except for their position. In the method 34, information for manufacturing the first region 38a can therefore be stored in the file 26 (see FIG. 1) and the position of the second region 38b can also be stored, as well as the information that the second region 38b is designed to be the same, in particular identical, to the first region 38a—except for its position. This means that not all of the manufacturing coordinates for manufacturing the second region 38b need to be stored in the file 26 (see FIG. 1), which saves memory space.

FIG. 3 shows the first region 38a. FIG. 3 shows the meandering path of the tool 16 in the form of a laser beam for filling the first region 38a. The parallel solid lines (mark lines “M”) are exposed and the laser beam is preferably switched off or blanked at the dashed connections of these lines or the laser power is at least reduced to such an extent that the powder material is not melted (jump “J”). Instead of storing all the manufacturing coordinates of the meander in the file 26 (see FIG. 1), at least one vector 40a, 40b can be stored in the file 26, which characterize the outline of the filling. Together with the algorithm 32 (see FIG. 1) for filling this outline, all information for filling the first region 38a can be provided in a memory-saving manner. In the present case, in which the first region 38a is rectangular, one of the vectors 40a, b would also be sufficient, together with an algorithm 32 (see FIG. 1) which defines the length of the lines M, to define all the information for filling the first region 38a.

As described above, embodiments of the invention relate to a method 34 for compressing the volume of data of a file 26 for guiding a tool 16 along manufacturing coordinates for the additive manufacturing of a component 14 in a computer 27. In this case, at least one vector 40a, b is determined and stored in the file 26, which, together with an algorithm 32, defines manufacturing parameters for filling a first region 38a of the component 14. The algorithm 32 can be stored in the file 26 or stored in a library 30 and reference can be made to the algorithm 32 in the file 26. Alternatively or additionally, a second region 38b of the component 14 to be filled can be defined in the file 26 by defining a first region 38a in the file 26 and storing in the file 26 where the second region 38b is to be formed and that said second region is to be formed in the same way as the first region 38a. In addition to a second region 38b, this method 34 can be continued for any number of additional regions. In a method 12 according to embodiments of the invention for manufacturing the component 14, the manufacturing parameters are calculated back to manufacturing coordinates. Embodiments of the invention also relate to a device 10 for carrying out the method 12 for manufacturing the component 14.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Device for manufacturing the component 14
12 Method for manufacturing the component 14
14 Component
16 Tool
18 Layer
20 Beam source
22 Deflection device
24 Control system
26 File
27 Computer
28 Memory
30 Library
32 Algorithm
34 Method for reducing the volume of data in the file 26
36 Grid
38a-c Region
40a, b Vector

1. A computer-implemented method for reducing a volume of data in a file for controlling additive manufacturing of a component by guiding a tool along manufacturing coordinates, the method comprising:
identifying a first region to be manufactured; and
I)
identifying a filling of the first region;
calculating a vector characterizing an outline of the first region;
storing the vector in the file; and
storing an algorithm for calculating the manufacturing coordinates of the filling or information relating to the algorithm to be applied in the file, so that the vector and the algorithm form manufacturing parameters which contain information of the manufacturing coordinates;
and/or
II)
storing the manufacturing coordinates or the manufacturing parameters of the first region in the file;
identifying a second region to be manufactured, wherein the second region is to be manufactured offset from the first region and to be manufactured identically to the first region; and
storing a position of the second region and information indicating that the second region is to be manufactured identically to the first region in the file.

2. The method according to claim 1, wherein the first region is two-dimensional in a layer of the component to be manufactured.

3. The method according to claim 2, wherein the layer of the component to be manufactured is divided into several regions, one of which is the first region.

4. The method according to claim 2, wherein the outline of the first region is trapezoidal.

5. The method according to claim 4, wherein the outline is rhombic.

6. The method according to claim 4, wherein the outline is rectangular.

7. The method according to claim 1, wherein the algorithm is configured to calculate the manufacturing coordinates for meandering guidance of the tool.

8. The method according to claim 1, wherein the second region is manufactured identically to the first region except for a position and a rotation of the second region.

9. The method according to claim 1, wherein the second region is manufactured identically to the first region except for a position of the second region.

10. A method for additive manufacturing of a component, the method comprising:
carrying out the method according to claim 1;
accessing the stored file;
calculating the manufacturing coordinates in the first region and/or the second region;
guiding the tool based on the manufacturing coordinates.

11. The method according to claim 10, wherein the tool is in a form of a laser beam.

12. The method according to claim 11, wherein the component is manufactured by powder bed-based laser melting.

13. A device for carrying out a method according to claim 10, the device comprising a computer for reducing the volume of data, the tool, a control system, and a memory, wherein the file is stored in the memory.
